(19) United States
(12) Patent Application Publication
(10) Pub. No.: US 2018/0074995 A1
(43) Pub. Date: Mar. 15, 2018

(54) Numerically Stable and Convergent Non-Symmetric Eigendecomposition method for Noise and Timing Simulator in Software and Hardware

(71) Applicants: BHARATENDU SOUMIL, RUDRAPUR (IN); BHUWAN KUMAR AGRAWAL, RUDRAPUR (IN)

(72) Inventors: BHARATENDU SOUMIL, RUDRAPUR (IN); BHUWAN KUMAR AGRAWAL, RUDRAPUR (IN)

(21) Appl. No.: 15/261,885

(22) Filed: Sep. 10, 2016

(51) Int. Cl. G06F 17/16

(52) U.S. Cl. CPC G06F 17/16

(57) ABSTRACT

Timing and noise simulations methods in commercial tools use forced symmetric matrix formulation of the state space system matrix. Such methods use approximations to complex non-symmetric model of interconnect, thereby grossly approximating the effects of coupling capacitances and inductances. A stable and accurate method for eigendecomposition is discussed, for dense, non-symmetric matrices using numerically stable and accurate eigenstamps of size 2×2. Eigenstamps hold complex Schur vectors of the respective block. The method is proposed for VLSI hardware implementation of noise and timing processor because of negligible numerical errors in eigenstamps and guaranteed global convergence. The tool handles complex matrices and is implemented in double precision complex arithmetic.

### FIELD OF THE INVENTION

The invention presented here relates to an accurate tool for computing the complete time-domain response of an RLC interconnect model, including all coupling sources. The complete time-domain simulation requires the solution to the non-symmetric eigenvalue problem. This is computed with the aid of a novel eigendecomposition algorithm, which is also a vital part of this invention.

### BACKGROUND

Current, tools used in the industry utilize forced symmetric matrix formulation of the system matrix to obtain the complete time domain response of an RLC interconnect system. Such approximations ignore, the effects of inductive/capacitive coupling. Inclusion of these coupling elements leads to a non-symmetric system. The method described here solves this problem with the aid of a non-symmetric eigendecomposition algorithm, referred to as the “eigenstamps” methodology throughout the text. This eigendecomposition algorithm assures convergence for large matrices. The double shifted QR algorithm is the most practical eigendecompositon algorithm used for computing eigenvalues, however there is no method in place to handle rare cases where the eigenvalues do not converge. The “eigenstamps” methodology described here addresses this issue by providing an accurate, stable and convergent algorithm.

### BRIEF SUMMARY

Numerically stable matrix eigendecompositon is very useful in solving differential equations and partial differential equations when it is desired to calculate matrix functions such as the exponential of a matrix. The eigendecomposition method described here is called the “eigenstamps” method and works very well for non-defective matrices to compute accurate eigenvalues and eigenveetors. The accuracy of the method can be attributed to the fact that the entire process depends solely on the dynamic characterization and accuracy of the 2×2 eigenstamps selected in each iteration. This algorithm is then used to compute the complete time-domain response of the system, inclusive of all coupling elements. The fact that this method can easily be converted to Verilog, makes it a great choice for hardware implementation and virtual prototyping.

### BRIEF DESCRIPTION OF THE DRAWINGS

FIG. 1 represents the RLC interconnect model of a coupled network, where Lp1, Lp2, Cp1, and Cp2 are the coupling inductances and the coupling capacitances respectively.

FIG. 2 represents the overall design process to compute the complete response of the system. It shows the different modules that can be programmed and integrated in hardware to provide noise and timing analysis. This is essentially a high level description of the entire design process.

FIG. 3 shows how the software can be easily converted to Verilog and then can be implemented on hardware or used for Virtual prototyping on FPGA machines such as Xilinx to obtain the noise/timing simulation results.

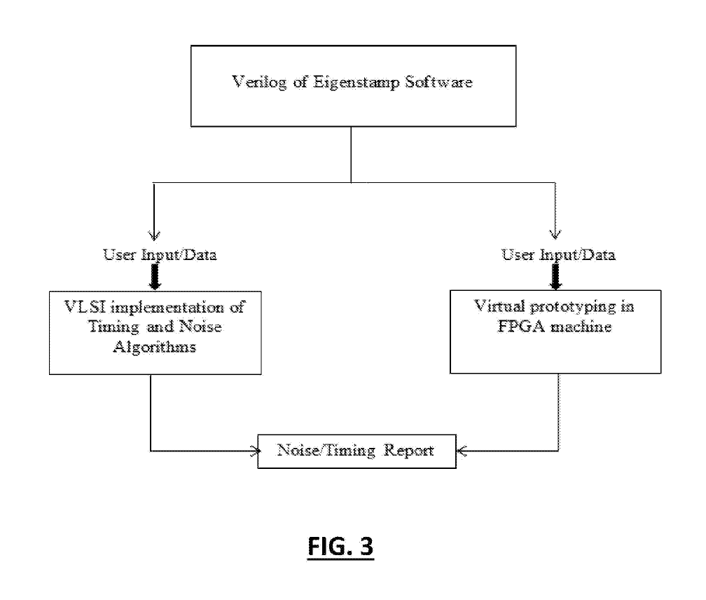

FIG. 4 is shows the computation of the eigenvalues/vectors using the Eigenstamps methodology. The “LT cost” here is the L2 norm of the lower triangular elements of the matrix.

FIG. 5 shows how the 2×2 Eigenstamps are constructed and then extended to the n×n case.

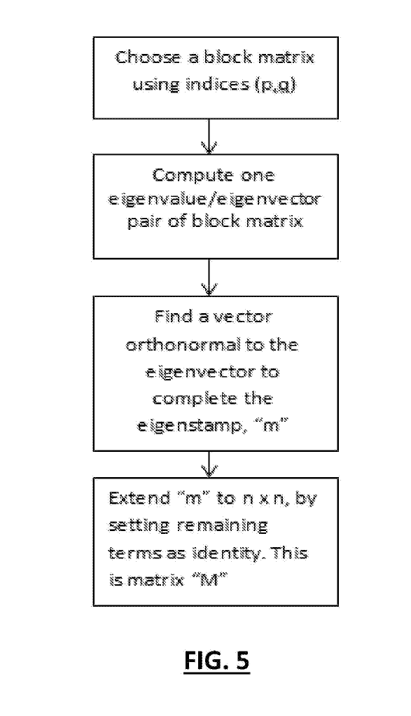

FIG. 6 is an illustration of a single stage RLC interconnect with coupling. Here Net 2 and Net 3 acting as aggressors to the victim Net 1.

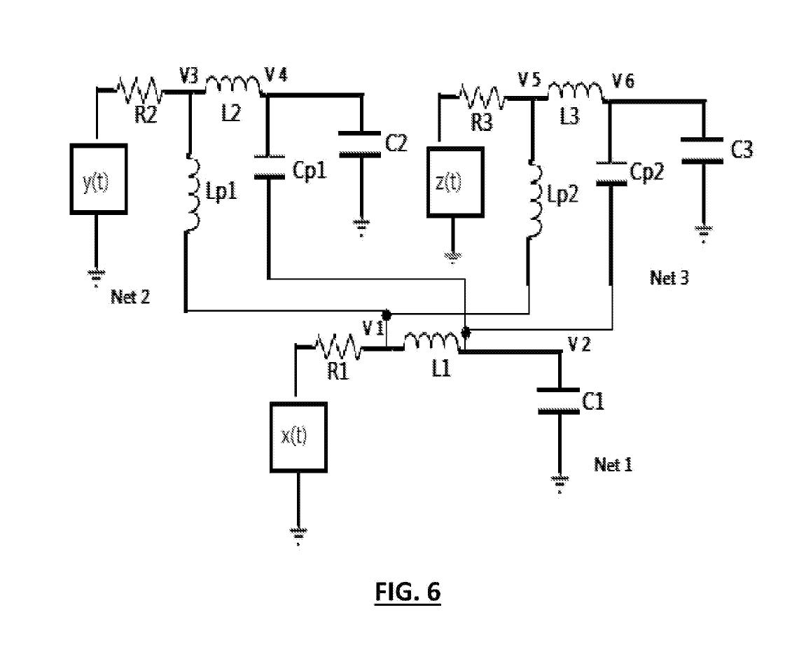

FIG. 7 represents the implicit update multiplication scheme for very large matrices. The arrows from/to the hard disk drive essentially represent read/write operations respectively.

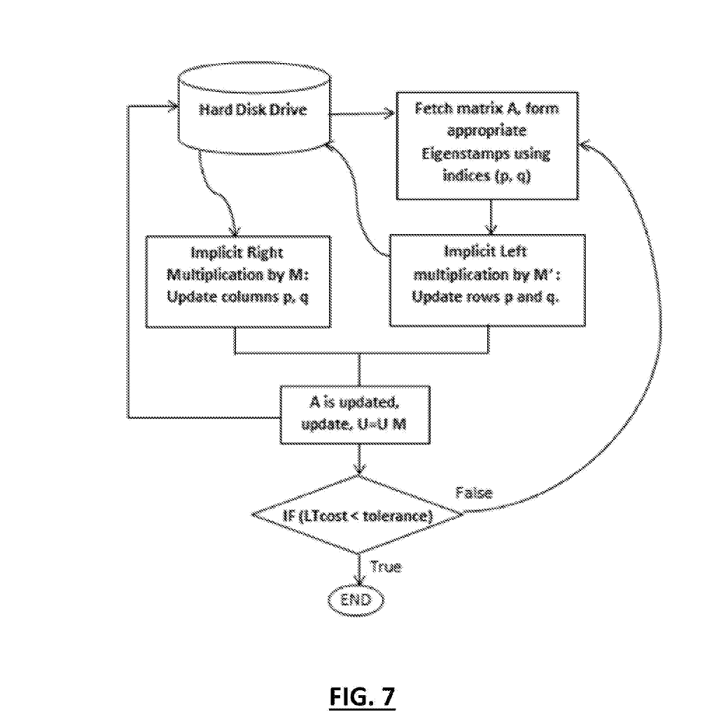

FIG. 8 is a sample illustration demonstrating the effect of coupling on the nodal voltage ‘V2’.Plot of ‘V2’ vs time is displayed with and without the coupling capacitances/inductances.

### DETAILED DESCRIPTION

Current tools use forced symmetric matrix formulation to simulate timing in RLC interconnects. This symmetry comes from the fact that all coupled passive elements are approximated by directly connecting, them to ground, and therefore, the results of simulations lack accuracy. The invention discussed here avoids all such pitfalls by solving the exact problem, i.e. including all coupling capacitances/inductances. The complete timing simulation requires the solution to the non-symmetric eigenvalue problem. This problem is solved by using the dynamic eigenstamps algorithm. These eigenstamps offer high numerical accuracy, convergence, and ease of conversion to Verilog for hardware design or virtual boxes like Xilinx.

The construction of the aforementioned eigenstamps just requires computation of one accurate eigenvector for a random 2×2 block, and the second vector is chosen as the vector orthonormal to this eigenvector. The eigenstamps are constructed from a 2×2 block in each iteration, extended to n×n, and followed by a similarity transformation in order to preserve the matrix eigenvalues in each iteration. At convergence, we obtain an upper triangular matrix with the eigenvalues along the main diagonal, and the corresponding matrix of Schur Vectors.

The selection of these eigenstamps is determined by applying the probabilistic Monte-Carlo algorithm to select a new 2×2 block per iteration. The algorithm essentially works at the local level to optimize the global cost function. The cost function is simply the L1-norm of the lower triangular elements. The reason to why this algorithm guarantees convergence of Eigenpairs, is that it gets out of any potential local minima/traps by using Monte Carlo probabilistic “hill climbing”. This prevents the eigenvalues from getting trapped in these local minimas, and thus assures convergence of all eigenvalues. Although the double shifted-QR algorithm is the most efficient algorithm currently available in terms of speed, however the method doesn't guarantee convergence, as there is no algorithm that prevents any potential cycling/oscillations that may occur in certain cases.

Eigenstamps may be programmed for diagonal form, defective matrices, and Schur decomposition, depending on the application in hand. Eigenstamps can be programmed exactly what we want them to do at the global level.

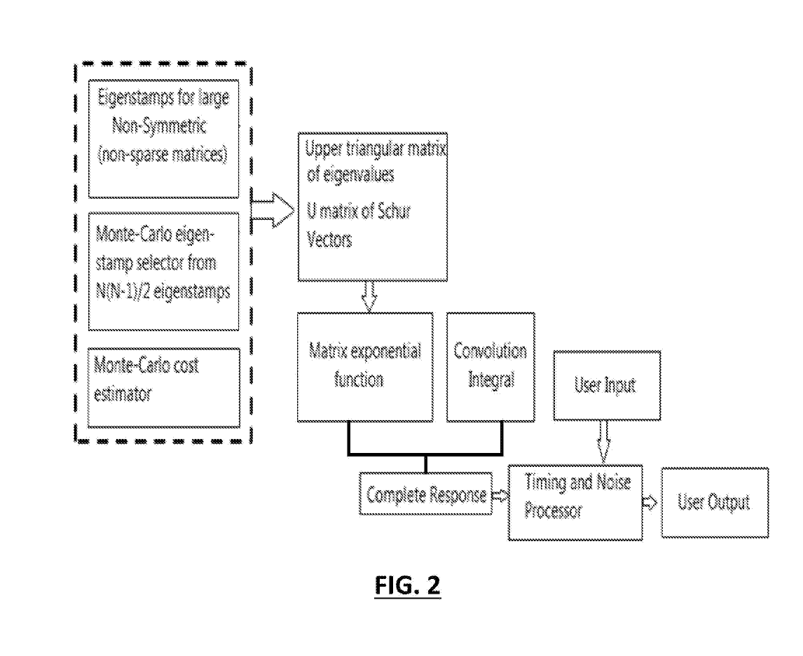

The first module shown in FIG. 2. is an eigensolver for the large non-symmetric system matrix. The second module evaluates the matrix exponentials and the convolution integral which together make the complete response of the system. The complete response is essentially the timing simulation of the RLC network including all coupling sources. Formulation of the eigenstamps requires the following steps. Consider the following matrix 3×3 matrix

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] .$$

The general idea is to select two indices, p and q in each iteration, in order to select a 2×2 block matrix which is used during the matrix triangularization process. The block is formed

$$as ( \begin{matrix}{a}_{pp} & {a}_{pq} \\ {a}_{qp} & {a}_{qq}\end{matrix} ) , p < q .$$

For the 3×3 A matrix shown above, the different block configurations that can be used to compute the eigenpairs of this matrix are shown below.

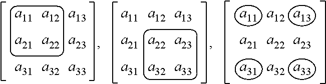

The matrix elements enclosed inside the grey boxes essentially represent the different possible combinations of the indices p and q that can be used in triangularization process. The values of p and q are such that the diagonal elements of the n×n matrix always happen to be along the diagonal of the block matrix. Such a configuration ensures a similarity transformation, i.e. retention of the matrix eigenvalues. Selecting a random 2×2 block that does not follow this property cannot be used in this algorithm. The next step involves the computation of the eigenvalues and Schur vectors of each of these block matrices. The only requirement for the eigenstamp method is finding the exact single root of quadratic or cubic polynomial with highest precision in double complex arithmetic. The vectors are then essentially computed by finding one eigenvector from the 2×2 block, and finding a vector orthonormal to this vector as the second Schur vector. These two vectors complete the 2×2 eigenstamp matrix “m”. This matrix m is then promoted to n×n, called “M”, by padding the remaining terms to Identity. The following iterations eventually lead to the matrix triangularization.

A₁=M*A M;

A₂=M₁*A₁M₁;

A₃=M₂*A₂M₂ . . . .

T=(M M1 . . . Mₙ₋₁)*A(M M₁ . . . Mₙ₋₁)=Q*A Q (1)

Numerically accurate eigenstamps and proper order of selection of (i, j) indices leads to convergence to an accurate set of eigenpairs. The order of selection of (i, j) is determined using the Monte Carlo algorithm, and this affects the rate of convergence to a great extent. Before updating the A matrix, we perform a quick lower triangular cost check. If the current cost is lower than the cost incurred in the previous iteration, we accept that move. Otherwise, the move is rejected or accepted with some probability using Monte-Carlo hill climbing criteria.

Equation (1) essentially represents the Schur Factorization of the matrix A using the eigenstamps method. Here Q is a matrix of Schur vectors, i.e. its columns form an orthonormal basis. T is an upper-triangular matrix with the eigenvalues along the main diagonal. The following example is a simple illustration of the Schur Decomposition of matrix A using this method:

$$A = [ \begin{matrix}1 & 10 & 2 \\ 0 & - 1 & 0 \\ 3 & - 1 & 3\end{matrix} ]$$

$$( p , q ) = ( 1 , 3 ) = > m = [ \begin{matrix}- 0.4809 & 0.8767 \\ - 0.8767 & - 0.4809\end{matrix} ]$$

$$M = [ \begin{matrix}- 0.4809 & 0 & 0.8767 \\ 0 & 1 & 0 \\ - 0.8767 & 0 & - 0.4809\end{matrix} ]$$

$$A 1 = {M}^{*} AM = [ \begin{matrix}4.6458 & - 3.9329 & - 1 \\ 0 & - 1 & 0 \\ 0 & 9.2484 & - 0.6458\end{matrix} ]$$

$$( p , q ) = ( 2 , 3 ) = > m 1 = [ \begin{matrix}0 & - 1 \\ 1 & 0\end{matrix} ]$$

$$M 1 = [ \begin{matrix}1 & 0 & 0 \\ 0 & 0 & - 1 \\ 0 & 1 & 0\end{matrix} ]$$

$$A 2 = {M}_{1}^{*} {A}_{1} M = T = [ \begin{matrix}4.6458 & - 1 & 3.933 \\ 0 & - 0.6458 & - 9.2484 \\ 0 & 0 & - 1\end{matrix} ] = > Q = MM 1 = [ \begin{matrix}- 0.481 & 0.876 & 0 \\ 0 & 0 & - 1 \\ - 0.876 & - 0.481 & 0\end{matrix} ]$$

As it can be seen from the above example, the columns of the matrix Q form an orthonormal basis. This case required only 2 iterations to converge to triangular form. The eigenvectors of A are obtained by solving for x in the decoupled singular linear system (T−λᵢI) xᵢ=0, setting appropriate values for the free variables, wherever applicable.

=>Eigerivectors of A=Q xᵢ. (2)

In order to reduce the computation cost and possibility for errors, the matrix multiplications are done implicitly, rather than multiplying large non-sparse n×n matrices. In the actual implementation, we really don't perform the actual left and right multiplication with ‘A’ matrix. Instead, only the affected rows and columns are updated in the left and right multiplication. For the left multiplication of matrix A with M*, only elements of row p and q change, the remaining elements remain unchanged. Similarly, for right multiplication of matrix A with matrix M, only elements of columns p and q are updated, the remaining terms remain unchanged. This implicit multiplication scheme is really a necessity if the matrices are very large, mainly because matrix multiplication is an O (n³) process and it's very impractical to multiply two large matrices. This implicit method uses 8n²-4n flops for both left and right multiplication with A. The method offers both faster computation and lesser room for numerical errors.

At convergence: U=Schur Vectors, A=Upper triangular matrix.

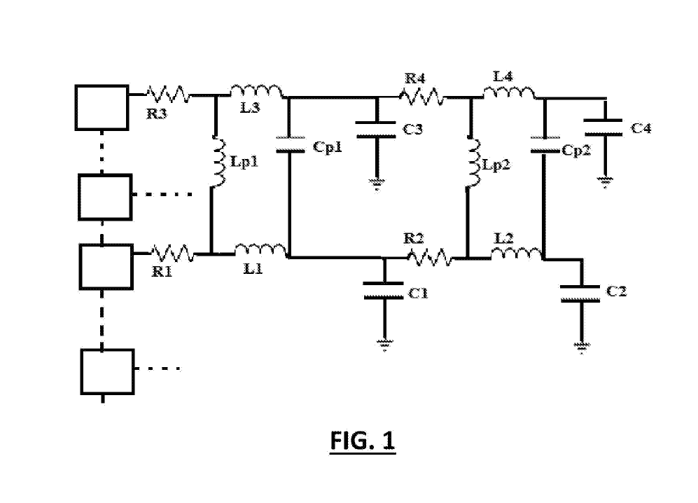

The system matrix in the state space formulation is non-symmetric in nature and therefore requires a fast and numerically stable solution for the non-symmetric eigenvalue problem. Timing and noise analysis tools sweep Performance Evaluation and Review Technique (PERT) based algorithm from primary inputs/clocks to primary outputs/latches adding gate and interconnect delays in between. The toughest challenge had been lack of an accurate algorithm which guarantees convergence for computing noise on the victim fine with thousands of aggressors. The method discussed here avoids such pitfalls, instead solves the exact problem, by including mutual inductance/capacitances, and thousands of aggressor coupled lines. FIG. 1 is an RLC interconnect model with coupling.

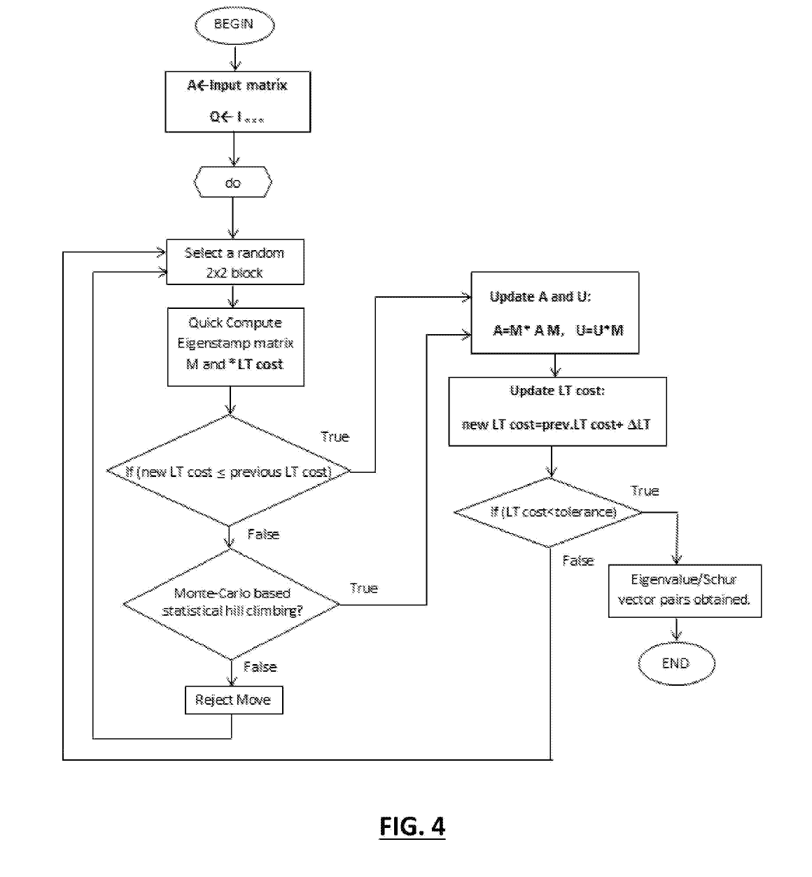

The spectral decomposition technique discussed so far can be applied efficiently in order to compute the effect of ‘n’ capacitive and inductive couplings in an RLC network, on the victim line. The eigenvalues/vectors of the system are pivotal in the computation of the complete response of the system. In FIG. 4, we provide a simple example showing the impact of two capacitive and inductive couplings, just for illustrative purposes. Here we have two capacitive couplings Cp1, Cp2 and two inductive couplings Lp1, and Lp2, driven by x (t), y (t), and z (t) respectively. Therefore, Net 2 and Net 3 act as aggressors to the victim Net 1. Our objective is to form a generalized state space model to compute the impact of ‘n’ coupling capacitances/inductances on the victim line. This problem is converted to a state space model by using Kirchhoff's Current and Voltage Laws as expressed by (3) to (10).

$$\begin{matrix}K \cdot V {2}^{′} = {I}_{L 1} + \frac{Cp 1 {I}_{L 2}}{( Cp 1 + Cp 2 )} + \frac{Cp 2 {I}_{L 3}}{( Cp 2 + Cp 3 )} & ( 3 ) \\ ( Cp 1 + C 2 ) V {4}^{′} = {I}_{L 3} + Cp 1 V {2}^{′} & ( 4 ) \\ ( Cp 2 + C 3 ) V {6}^{′} = {I}_{L 3} + Cp 2 V {2}^{′} & ( 5 ) \\ L 1 {I}_{L 1}^{′} = x ( t ) - V 2 - ( {I}_{Lp 1} + {I}_{Lp 2} + {I}_{L 1} ) R 1 & ( 6 ) \\ L 2 {I}_{L 2}^{′} = y ( t ) - V 4 - ( {I}_{Lp 1} + {I}_{L 2} ) R 2 & ( 7 ) \\ L 3 {I}_{L 3}^{′} = 2 ( t ) - V 6 - ( {I}_{Lp 2} + {I}_{L 3} ) R 3 & ( 8 ) \\ Lp 1 {I}_{Lp 1}^{′} = ( y - x ) - ( {I}_{Lp 1} + {I}_{L 2} ) R 2 + ( {I}_{Lp 1} + {I}_{Lp 2} + {I}_{L 1} ) R 1 & ( 9 ) \\ Lp 2 {I}_{Lp 2}^{′} = ( z - x ) - ( {I}_{Lp 2} + {I}_{L 3} ) R 3 + ( {I}_{Lp 1} + {I}_{Lp 2} + {I}_{L 1} ) R 1 , \\ where K = Cp 1 + Cp 2 + C 1 - \frac{Cp {1}^{2}}{( Cp 1 + C 2 )} - \frac{Cp {2}^{2}}{( Cp 2 + C 3 )} & ( 10 )\end{matrix}$$

The state variables in this case are, V2, V4, V6, I_{L1}, I_{L2}, I_{L3}, I_{Lp1}, I_{Lp2}. The state space equation is represented as V′=AV+Bu. The system matrix A, matrix B may be constructed using (3) to (10), where ‘u.’ is the column vector of the drivers, i.e., <x (t), y (t), z(t)>. These equations may be generalized to the n×n case as expressed by (11) to (15). These expressions are derived by taking “n” such single stage aggressors acting on a particular victim.

$$\begin{matrix} K \cdot V {2}^{′} = {I}_{L 1} + {\sum }_{i = 1}^{i = N} \frac{{Cp}_{i} {I}_{L + 1}}{( Cpi + {C}_{i + 1} )} & ( 11 ) \\ ( {Cp}_{i} + {C}_{i + 1} ) {V}_{( 2 i + 2 )}^{′} = {I}_{{L}_{i + 1}} + {Cp}_{i} V {2}^{′} & ( 12 ) \\ L 1 {I}_{L 1}^{′} = x ( t ) - V 2 - ( {\sum }_{i = 1}^{i = N} {I}_{Lpi} + {I}_{L 1} ) R 1 & ( 13 ) \\ {L}_{i + 1} {I}_{{L}_{i + 1}}^{′} = driver ( t ) - {V}_{2 i + 2} - ( {I}_{{Lp}_{i}} + {I}_{{L}_{i + 1}} ) {R}_{i + 1} & ( 14 ) \\ {Lp}_{i} {I}_{{Lp}_{i}}^{′} = ( driver ( t ) - x ) - ( {I}_{{Lp}_{i}} + {I}_{{L}_{i + 1}} ) {R}_{i + 1} + ( {I}_{L 1} + {\sum }_{i = 1}^{i = N} {I}_{Lpi} ) R 1 \\ K = C 1 + {\sum }_{i = 1}^{i = N} ( {C}_{pi} - \frac{{Cpi}^{2}}{Cpi + {C}_{i + 1}} ) & ( 15 )\end{matrix}$$

Note i=1, 2, 3, 4 . . . n, where n=number of coupling capacitors/inductors.

The complete state space response of this system is computed using the matrix exponential to simplify our computations. The complete time-domain response of the system is expressed as:

V(t)=e^{At}V(0)+∫₀^{t}e^{A(t-τ)}Bu(τ)dτ. (16)

Once we obtain the system matrix A the Eigenstamps methodology described earlier comes into play, to compute the matrix exponential, which is expressed as e^{At}=M e^{Dt}M⁻¹, where M is the matrix of eigenvectors and D is the diagonal eigenvalue matrix. In order to reduce the overall computation cost and complexity of implementation we decouple the n×n system by applying a change of variable V=M Vₙ.

M Vₙ(t)=e^{At}MVₙ(0)+∫₀^{t}e^{A(t-τ)}Bu(τ)dτ=>Vₙ(t)=e^{Dt}Vₙ(0)+∫₀^{t}e^{A(t-τ)}M⁻¹Bu(τ)dτ. (17)

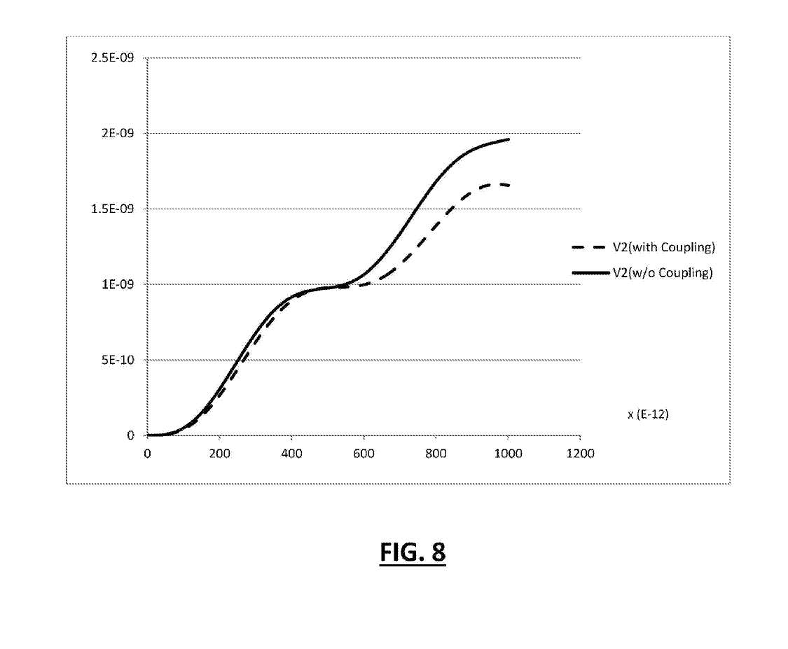

FIG. 8 illustrates the effect of inductive and capacitive coupling on the nodal voltage V2. The following values of the parameters were used, for simulating V2 vs time: {R1=2, L1=3, C1=2}, {R2=3, L2=1, C2=4}, {R3=1, L3=3, C3=5}, {Lp1=0.6, Lp2=0.69, Cp1=0.2, Cp2=0.24}, (units: R=Ω, C=pF, L=nH, x=y=z=2t (ramp input)). Cleary, the inclusion of coupling elements leads to deviation from the original curve (without coupling).

Due to its numerical stability, and accuracy this method is used instead of the traditional Runge-Kutta differential equation solvers, and truncated exponential series.

What is claimed is:

1. An accurate Eigendecomposition algorithm that guarantees convergence regardless of the type or size of a matrix by getting out of any potential eigenvalue traps.

2. An accurate tool for computing the complete time-domain response of a RLC interconnect, which includes all sources of capacitive/inductive coupling.

3. The noise/timing tool in claim 2 can be then used for Hardware implementation for faster execution, by converting the existing C++ code to Verilog, and loading it to hardware.
